(19) United States
(12) Patent Application Publication
(10) Pub. No.: US 2003/0042118 A1
(43) Pub. Date: Mar. 6, 2003

(54) Static induction device for activating switches

(76) Inventor: Jung-Tsung Wei, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/946,350

(22) Filed: Sep. 6, 2001

(51) Int. Cl. H01H 9/00

(52) U.S. Cl. 200/331

(57) ABSTRACT

A device for activating a switch includes a thread connected to a switch and a hollow casing is connected to a free end of the thread. A body is received in the casing and a space is defined between the body and an inside of the casing. An earth line is connected to the body and extends through the casing so that when touching the casing or the earth line, the body is shake and contacts the inside of the casing to form a circuit to activate the switch.

### FIELD OF THE INVENTION

The present invention relates to a switch including a conductive thread and an operation member on a free end of the thread. The thread and the operation member are activated by static electricity.

### BACKGROUND OF THE INVENTION

A conventional switch for operation of a ceiling fan or a ceiling light is shown in FIG. 1 and generally includes a thread 1 connected to a switch in the ceiling fan or the ceiling light and a stop 11 is connected to a free end of the thread 1. When in operation, the user's hand has to hold the thread 1 or the stop 11 as shown in FIG. 2 and pulls the thread 1 to activate the switch as shown in FIG. 3. The number of the time that the thread 1 is pulled functions the switch to perform different actions. After the switch is activated, the thread 1 is released as shown in FIG. 4. It is difficult to catch the thread 1 in a dark room and the thread 1 has to be pulled vertically so as to precisely operate the switch. If the thread 1 is pulled at an angle relative to a vertical plain, the switch could not be operated. Besides, the thread 1 could bounce up if the thread 1 is released suddenly and is tangled by the rotating fan blades or the light.

The present invention intends to provide a static induction device connected to a switch which is activated simply by touch on the device.

### SUMMARY OF THE INVENTION

In accordance with one aspect of the present invention, there is provided a device for activating a switch and comprises a thread connected to a switch and a hollow casing is connected to a free end of the thread. A body is received in the casing and a space is defined between the body and an inside of the casing. An earth line is connected to the body and extends through the casing so that when the casing is touched, the body contacts the inside of the casing so as to activate the switch.

The primary object of the present invention is to provide a static induction device that activates a switch by touching the device.

The present invention will become more obvious from the following description when taken in connection with the accompanying drawings which show, for purposes of illustration only, three preferred embodiments in accordance with the present invention.

### BRIEF DESCRIPTION OF THE DRAWINGS

FIGS. 1 to 4 show four individual actions for operating a conventional pull type switch;

FIG. 5 is an illustrative view to show a user's hand approaches the static induction device of the present invention;

FIG. 6 is a cross sectional view to show a body is hanged in a casing attached to a free end of a thread of the device of the present invention; and

FIG. 7 is a cross sectional view to show that the thread of the device of the present invention has a resilient section.

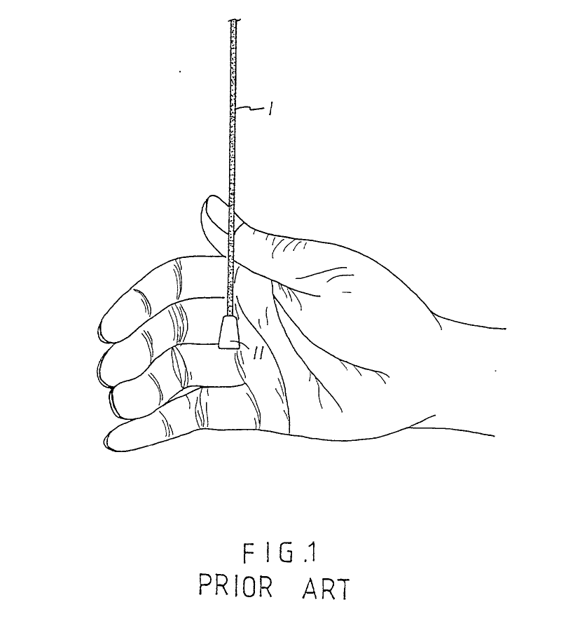

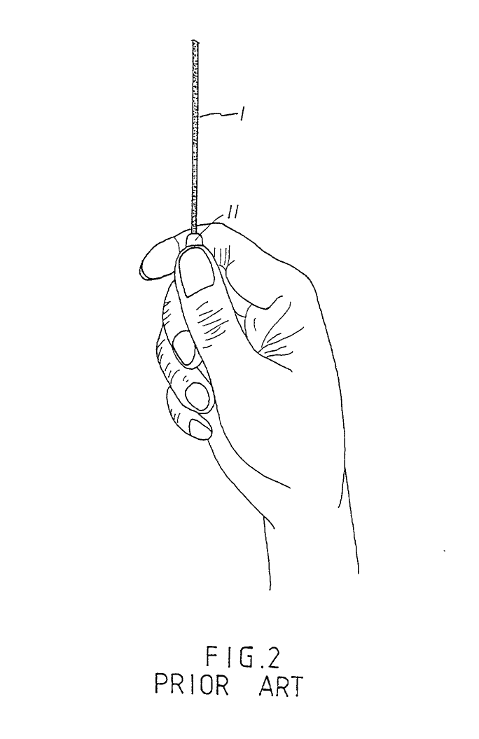

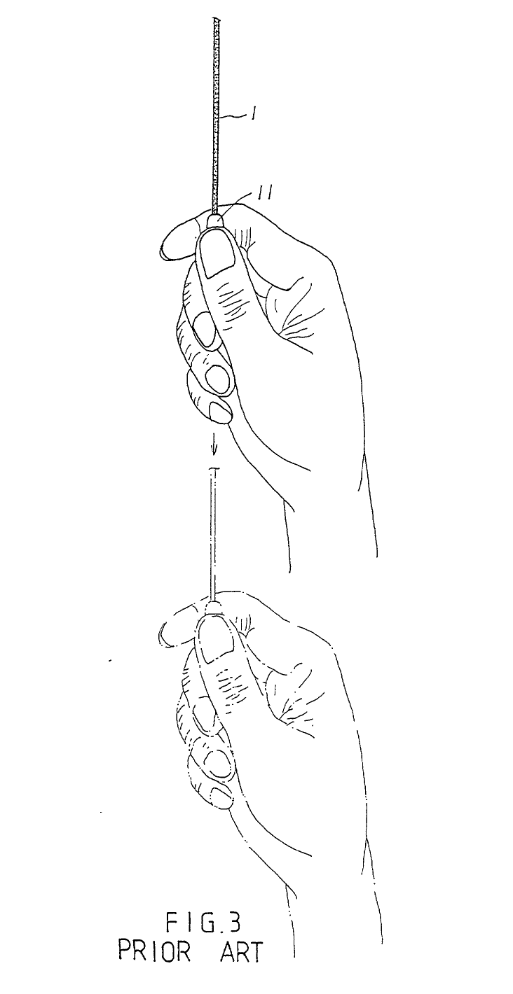

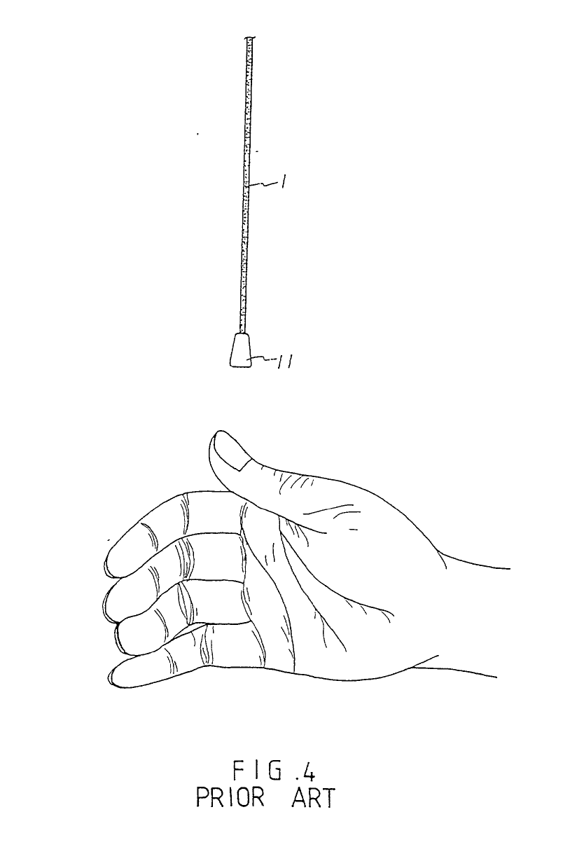

### DETAILED DESCRIPTION OF THE PREFERRED EMBODIMENTS

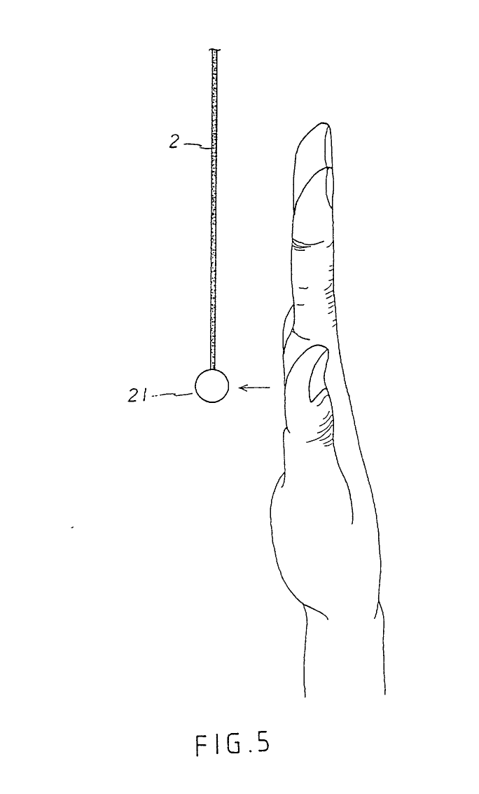

Referring to FIG. 5, the static induction device of the present invention comprises a conductive thread 2 having one end thereof connected to a switch and the other end of the conductive thread 2 is connected to a hollow casing 21. When a user's hand touches the conductive thread 2, the conductive thread 2 is activated and the switch is activated. The casing 21 maintains the vertical position of the conductive thread 2.

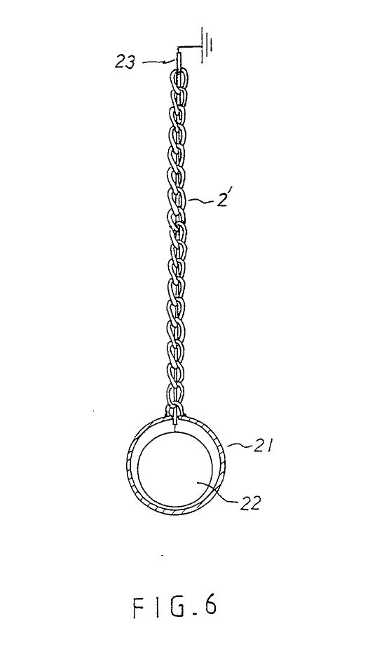

As shown in FIG. 6, The thread 2' can be non-conductive and a body 22 is received in the casing 21 and a space is defined between the body 22 and an inside of the casing 21. An earth line 23 is connected to the body 22 and extends through the casing 21 so that the body 22 is hanged in the casing 21 and does not contact the inside of the casing 21 when no external force is applied on the casing 21. When the user touches or pets the casing 21, the body 22 moves to contact the inside of the casing 21 so as to activate the switch.

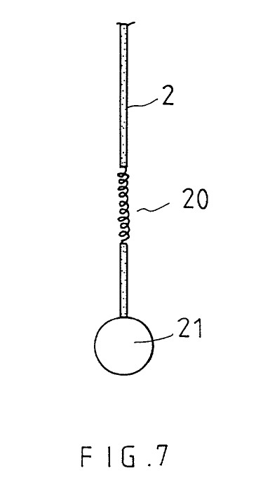

FIG. 7 shows that the conductive thread 2 includes a resilient section 20 so that the thread 2 is allowed the user to pull and the casing 21 is also shake to let the body 22 inside the casing 21 to contact the inside of the casing 21.

While we have shown and described the embodiments in accordance with the present invention, it should be clear to those skilled in the art that further embodiments may be made without departing from the scope of the present invention.

What is claimed is:

1. A device for activating a switch, comprising:
a conductive thread adapted to be connected to a switch and a hollow casing connected to a free end of said conductive thread.

2. The device as claimed in claim 1, wherein said conductive thread includes a resilient section.

3. A device for activating a switch, comprising:
a thread adapted to be connected to a switch and a hollow casing connected to a free end of said thread and
a body received in said casing and a space defined between said body and an inside of said casing.

4. The device as claimed in claim 3, wherein an earth line is connected to said body and extends through said casing.

5. The device as claimed in claim 3, wherein said thread includes a resilient section.
